(19) United States
(12) Patent Application Publication
(10) Pub. No.: US 2012/0257067 A1
(43) Pub. Date: Oct. 11, 2012

(54) SYSTEMS AND METHODS FOR FOCUS TRANSITION

(75) Inventor: Francisco Imai, Mountain View, CA (US)

(73) Assignee: CANON KABUSHIKI KAISHA, Tokyo (JP)

(21) Appl. No.: 13/083,970

(22) Filed: Apr. 11, 2011

(51) Int. Cl. H04N 5/232; H04N 5/225

(52) U.S. Cl. 348/207.1; 348/345; 348/E05.042

(57) ABSTRACT

Systems and methods for setting a focal transition for an image capturing device receive data including user selections of focal settings for respective areas of interest in an image, generate a first interface that includes indicators of the focal settings for the respective areas of interest, receive data including user selections of transitional focal settings for respective transitional areas between the areas of interest, and generate a second interface, the second interface including indicators of the transitional focal settings for the respective transitional areas between the areas of interest.

### BACKGROUND

1. Field of the Disclosure

The present disclosure relates generally to adjustment of focus in an image capturing device.

2. Description of the Related Art

A focal plane of an optical system is a plane that lies perpendicular to the optical axis and that passes through a focal point of the optical system. Rays of light that enter the optical system and that are parallel to the optical axis converge on the focal point. Typically, objects within the same focal plane appear equally sharp and objects out of a focal plane appear blurred relative to the objects in the focal plane. Some image capturing devices can capture images with more than one focal plane, for example by capturing light field images or by capturing multiple images, each with a different focal plane.

### SUMMARY

In one embodiment, a method for setting a focal transition for an image capturing device comprises receiving data including user selections of focal settings for respective areas of interest in an image, generating a first interface that includes indicators of the focal settings for the respective areas of interest and indicators of transitional focal settings for respective transitional areas between the areas of interest, receiving data including user selections of the transitional focal settings for the respective transitional areas between the areas of interest, and generating a second interface, the second interface including indicators of the transitional focal settings for the respective transitional areas between the areas of interest.

In one embodiment, a system for setting a focal transition comprises a computer-readable medium, an input interface configured to receive data indicating selections from a user, and one or more processors configured to cause one or more computing devices to generate a first interface indicating focal settings for respective areas of interest in an image, receive data indicating one or more user selections, the one or more user selections indicating focal settings for areas between the areas of interest in the image, and generate a second interface indicating the focal settings for the areas between the areas of interest in the image.

In one embodiment, one or more computer-readable media store instructions that, when executed by one or more computing devices, cause the one or more computing devices to perform operations comprising receiving one or more first user selections, the one or more first user selections indicating transitional focal settings between a first focal setting and a second focal setting, wherein the first focal setting is associated with a first area of an image, the second focal setting is associated with a second area of the image, and the transitional focal settings are associated with a transitional area of the image between the first area and the second area, and generating a first interface indicating the transitional focal settings between the first focal setting and the second focal setting.

### BRIEF DESCRIPTION OF THE DRAWINGS

FIG. 1 illustrates an embodiment of a system for adjusting focal transitions in an image.

FIG. 2 illustrates an embodiment of a transition adjustment device.

FIG. 3 is a block diagram that illustrates an embodiment of a method for adjusting focal transitions.

FIG. 4 is a block diagram that illustrates an embodiment of a method for adjusting focal transitions.

FIGS. 5A and 5B illustrate embodiments of interfaces that indicate areas of interest.

FIGS. 6A and 6B illustrate embodiments of interfaces that indicate focal transitions between areas of interest.

FIGS. 7A and 7B illustrate embodiments of interfaces that indicate focal transitions between areas of interest.

FIGS. 8A, 8B, 8C, and 8D illustrate embodiments of interfaces that indicate focal transitions between areas of interest.

FIG. 9 illustrates an example of an embodiment of an interface that indicates focal transitions between areas of interest.

FIG. 10 illustrates an example of an embodiment of a super-pixel.

### DETAILED DESCRIPTION

The following description is of certain illustrative embodiments, and the disclosure is not limited to these embodiments, but includes alternatives, equivalents, and modifications such as are included within the scope of the claims. Additionally, the illustrative embodiments may include several novel features, and a particular feature may not be essential to practice the systems and methods described herein

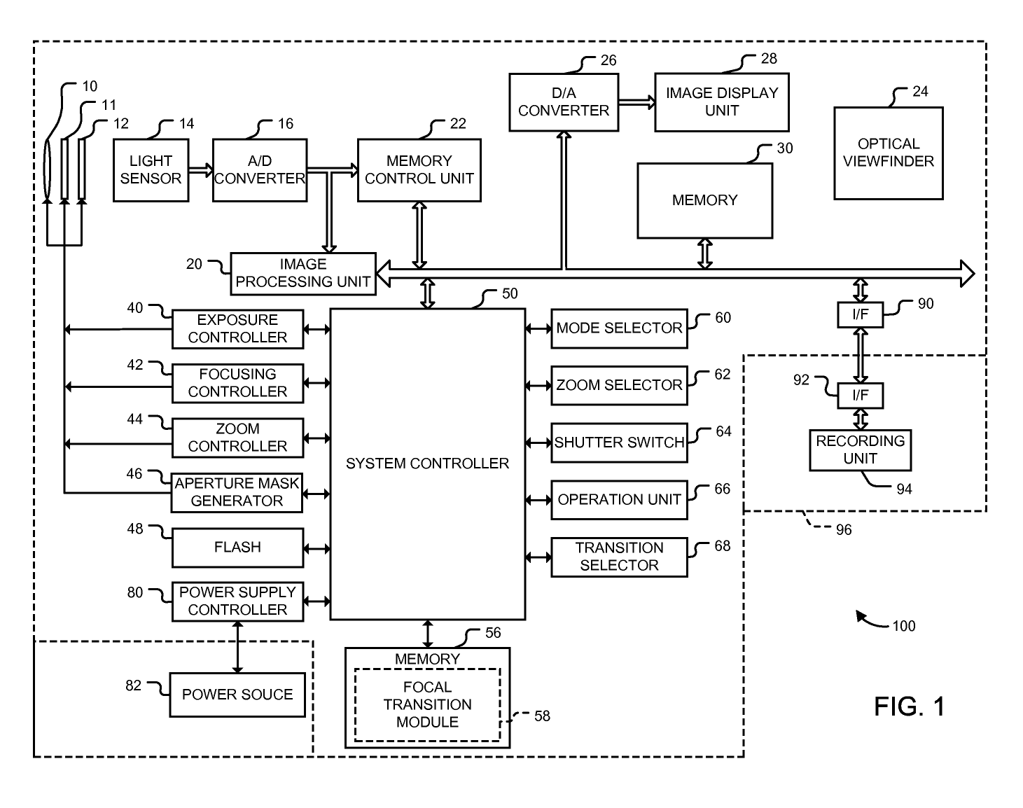

FIG. 1 illustrates an embodiment of a system 100 for adjusting focal transitions in an image. The system 100 receives an image of a scene and the focal settings for one or more areas of interest (e.g., anchored metering points, the center of gravity of a region of an RGB color, a user indicated area) in the image of the scene. The system 100 also generates an interface that indicates the areas of interest and their respective focal settings, and the system receives selections of transitional focal settings for the transitional areas between the areas of interest and generates an interface that indicates the selections. Thus, the system 100 allows a user to select transitional focal settings for the transitional areas between the areas of interest. The system 100 may also generate image capturing parameters (e.g., an aperture spatial mask, and electronic aperture mask) that configure one or more image capturing devices to implement the focal settings.

For example, an image may indicate two areas of interest that are in focus. The system 100 generates an interface (e.g., generates data that defines a graphical user interface) that indicates the two areas of interest and their respective focal settings, and the system 100 receives selections of focal settings for the transitional area between the areas of interest. The selections may indicate an abrupt transition, a gradual transition, etc., of the focal settings for the transition between the areas of interest. The system 100 also generates adjustments for image capturing parameters (e.g., parameters for one or more lenses, apertures, shutters, light sensors) that implement the selected focal settings. Thus, the focus and/or blurriness of the space between the areas of interest an image can be selected according to user preferences.

The system 100 includes a lens 10 (which may include a plurality of lenses), an aperture 11 (which may include a plurality of apertures, for example a multi-aperture array), a shutter 12, and a light sensor 14 (which may include a plurality of light sensors) that converts incident electromagnetic radiation into electrical signals. Furthermore, in other embodiments the lens 10, the aperture 11, and the shutter 12 may be arranged differently than is shown in the embodiment of FIG. 1, and the system 100 may include a plenoptic system and/or a polydipotric system.

Electromagnetic radiation (also referred to herein as “light”) reflected from a scene (e.g., an object in the scene) passes through the lens 10, the aperture 11, and the shutter 12 (when open) to the light sensor 14 and may form an optical image on a light sensing surface of the light sensor 14. The light sensor 14 converts the light to analog image signals and outputs the signals to an ND converter 16. The ND converter 16 converts the analog image signals to digital image signals. The light sensor 14 can detect light in the spectrum visible to the human eye and/or in the spectrum that the human eye cannot detect (e.g., infrared, x-ray, ultraviolet, gamma rays). In some embodiments, the light sensor 14 can detect light fields, for example four-dimensional light fields.

The system 100 also includes an image processing unit 20, which applies resize processing, such as predetermined interpolation and reduction, and color conversion processing to data from the ND converter 16 or data from a memory 30. The image processing unit 20 performs predetermined arithmetic operations using the captured image data, and the system 100 performs exposure control and ranging control based on the obtained arithmetic result. The system 100 can perform TTL (through-the-lens) AF (auto focus) processing, AE (auto exposure) processing, and EF (flash pre-emission) processing. The image processing unit 20 further performs TTL AWB (auto white balance) operations based on the obtained arithmetic result.

Output data from the A/D converter 16 is written in the memory 30 via the image processing unit 20 and/or memory control unit 22. The memory 30 stores image data that is captured by the light sensor 14 and converted into digital data by the A/D converter 16. The memory 30 may store images (e.g., still photos, videos) and other data, for example metadata and file headers for captured images. The memory 30 may also serve as an image display memory. A D/A converter 26 converts digital data into an analog signal and supplies that analog signal to an image display unit 28. The image display unit 28 presents images according to the analog signal from the D/A converter 26 on a display (e.g., an LCD, an LED display, an OLED display, a plasma display, a CRT display). The system 100 also includes an optical viewfinder 24 that presents at least part of the view detected by the light sensor 14.

An exposure controller 40 controls the shutter 12 and controls the size of the aperture(s) 11. The exposure controller 40 may also have a flash exposure compensation function that links with a flash 48 (e.g., a flash emission device). A focusing controller 42 controls the size of the aperture 11 and/or the position of the lens 10, and a zoom controller 44 controls the angle of view of the lens 10. The exposure controller 40, focusing controller 42, and zoom controller 44 may each partially control the lens 10, aperture 11, and shutter 12, and may also collaborate to calculate parameters for the lens 10, aperture 11, and shutter 12.

The aperture mask generator 46 generates masks that define aperture settings for respective apertures in an array of apertures. Additionally, the light sensor 14 may include super-pixels that each include a group of pixels. Each pixel in the group may be able to be independently associated with an aperture in a multi-aperture array (e.g., one pixel to one aperture, many to pixels to one aperture). The group of pixels may include various numbers of pixels (e.g., 2, 4, 8, 16), however, resolution may decrease as the number of pixels in the group increases. Thus, since light that passes through different apertures may be detected by at least one pixel in a group, a super-pixel may detect rays of light that each passes through a different aperture.

A memory 56 (as well as the memory 30) includes one or more computer readable and/or writable media, and may include, for example, a magnetic disk (e.g., a floppy disk, a hard disk), an optical disc (e.g., a CD, a DVD, a Blu-ray), a magneto-optical disk, a magnetic tape, semiconductor memory (e.g., a non-volatile memory card, flash memory, a solid state drive, SRAM, DRAM), an EEPROM, etc. The memory 56 may store computer-executable instructions and data for the operation of a system controller 50. The system controller 50 includes one or more processors (e.g., microprocessors) and reads and performs computer-executable instructions, such as instructions stored in the memory 56. Note that the computer-executable instructions may include those for the performance of various methods described herein. The memory 56 is an example of a non-transitory computer-readable medium that stores computer-executable instructions.

The memory 56 includes a focal transition module 58. A module includes computer-readable instructions that may be executed by one or more members of the system 100 to cause the system 100 to perform certain operations, though for ease of description a module may be described as performing the operations. Modules may be implemented in software (e.g., JAVA, C, C++, C#, Basic, Assembly), firmware, and/or hardware. In other embodiments, the system 100 may include more modules and/or the module may be divided into more modules. The instructions in the focal transition module 58 may be executed to cause the system 100 to set focal transitions, adjust focal transitions, and generate interfaces that indicate focal transitions and/or perform the methods described herein. Modules may be implemented in any applicable computer-readable storage medium that can be employed as a storage medium for supplying the computer-executable instructions. Furthermore, when the computer-executable instructions are executed, an operating system executing on the system 100 may perform at least part of the operations that implement the instructions.

The system 100 also includes a mode selector 60 that sets the operation mode of the system 100 to still image recording mode, video recording mode, playback mode, etc. A shutter switch 64 may be activated in the middle of operation (half stroke) and generate a first shutter switch signal. Also, the shutter switch 64 may be activated upon a full stroke and generate a second shutter switch signal. The system controller 50 may start one or more operations (e.g., AF processing, AE processing, AWB processing, EF processing) in response to the first shutter switch signal. Also, in response to the second shutter switch signal, the system controller 50 may perform and/or initiate one or more operations, including the following: reading image signals from the light sensor 14, converting image signals into image data by the A/D converter 16, processing of image data by the image processor 20, writing image data to the memory 30, reading image data from the memory 30, compression of the image data, and writing data to the recording medium 96.

A zoom selector 62 is operable by a user to change the angle of view (zooming magnification or shooting magnification). The zoom selector 62 may include, for example, a slide-type member, a lever, switch, a wheel, a knob, and/or a switch.

The operation unit 66 may include various buttons, touch panels and so on. In one embodiment, the operation unit 66 includes one or more of a menu button, a set button, a macro selection button, a multi-image reproduction/repaging button, a single-shot/serial shot/self-timer selection button, a forward (+) menu selection button, a backward (−) menu selection button, etc. The operation unit 66 may also set and change the flash operation mode. The settable modes include for example, auto, flash-on, red-eye reduction auto, and flash-on (red-eye reduction). The operation unit 66 may be used to select a storage format for the captured image information, including JPEG (Joint Photographic Expert Group) and RAW formats. The operation unit 66 may set the system 100 to a plural-image shooting mode, wherein a plurality of images is captured in response to a single shooting instruction (e.g., a signal from the shutter switch 64). This may include auto bracketing, wherein one or more image capturing parameters (e.g., white balance, exposure, aperture settings) are altered in each of the images.

A power supply controller 80 detects the existence/absence of a power source, the type of the power source, and a remaining battery power level, and supplies a necessary voltage and current to other components as required. A power source 82 includes a battery, such as an alkaline battery, a lithium battery, a NiCd battery, a NiMH battery, and an Li battery, an AC adapter, a DC adapter, etc.

The recording media 96 includes a recording unit 94 that is configured with one or more computer-readable and/or computer-writable media. The system 100 and the recording media 96 communicate via an interface 90 of the system 100 and an interface 92 of the recording media. Although the illustrated embodiment of the system 100 includes one pair of interfaces 90, 92 and one recording media 96, other embodiments may include additional recording media and interfaces.

The system 100 also includes a transition selector 68 that sets and/or adjusts focal transitions between areas of interest. The transition selector 68 may include, for example, one or more buttons, touch screens, dials, joysticks, wheels, levers, cameras, microphones, etc. For example, a user may touch a point on a touch screen that corresponds to a focal setting for a respective transitional area or a user may operate a joystick up, down, left, and/or right to select a transitional area and adjust the respective focal setting based on an interface that indicates the area(s) of interest, the transitional area(s), and/or the respective focal settings. The selector may also receive selections via other inputs, including, for example, voice command(s), eye gazing, eye movement, multi-touch, etc.

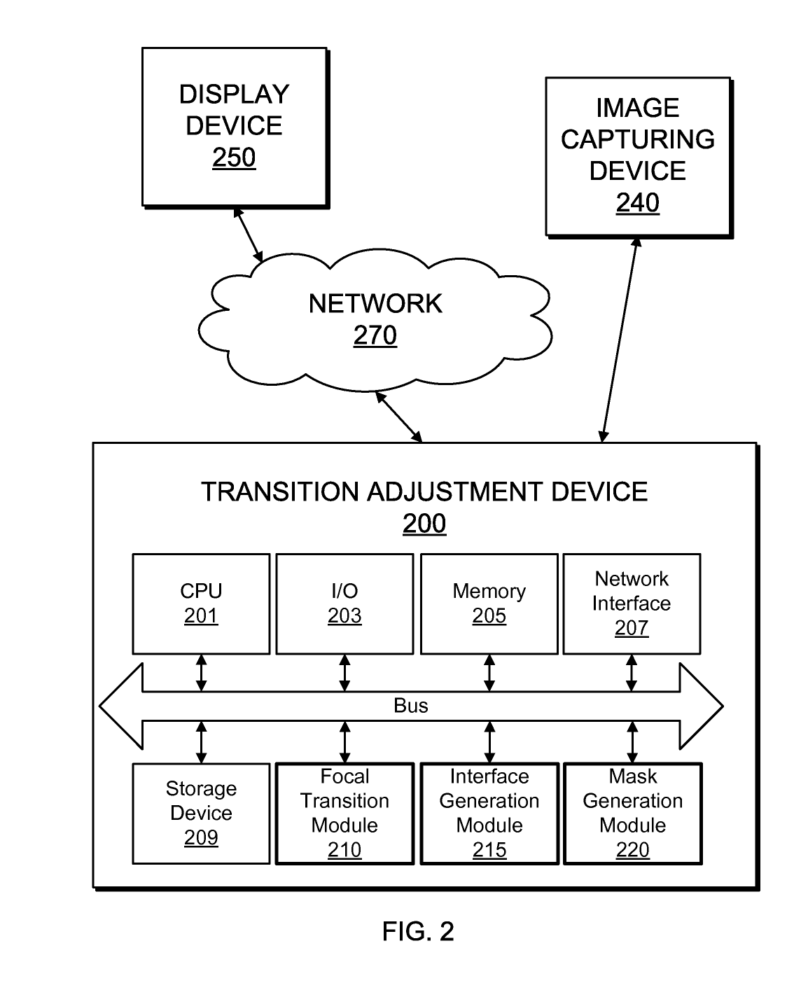

FIG. 2 illustrates an embodiment of a transition adjustment device 200. The transition adjustment device 200 communicates with a display device 250 and an image capturing device 240. In the embodiment shown, the transition adjustment device 200 communicates with the display device 250 via a network 270. The network 270 may include one network or any combination of networks, including the Internet, WANs, PANs, HANs, MANs, and LANs, as well as any combination of wired or wireless networks. The transition adjustment device 200 communicates with the image capturing device 240 via a direct connection (e.g., serial port, USB, IEEE 1394, Ethernet, HDMI), though in other embodiments the transition adjustment device 200, the display device 250, and the image capturing device 240 may communicate via different configurations than is illustrated in FIG. 2 (e.g., all communicate via direct connections, all communicate via one or more networks). The display device 250 is configured to render images and/or interfaces on a display (e.g., a plasma display, LED display, OLED display, CRT display, DLP display, LCD, a projector). The image capturing device 240 is configured to capture images of a scene (e.g., an RGB camera (standalone, cell phone, etc.), a computational camera).

The transition adjustment device 200 includes one or more processors 201 (also referred to herein as “CPU 201”), which may be conventional or customized central processing units (e.g., microprocessor(s)). The CPU 201 is configured to read and execute computer readable instructions, and the CPU 201 may command/and or control other components of the transition adjustment device 200. The transition adjustment device 200 also includes I/O interfaces 203, which provide communication interfaces to input and output devices, including a keyboard, a display (e.g., the display device 250), a mouse, a printing device, a touch screen, a light pen, an optical storage device, a scanner, a microphone, a camera, a drive, etc.

The transition adjustment device 200 additionally includes a memory 205, which includes one or more computer-readable and/or writable media. The network interface 207 allows the transition adjustment device 200 to communicate with the network 270 and other devices via the network 270, and the network interface 207 may have wired and/or wireless capabilities. The storage device 209 stores data, computer-executable instructions, and/or modules and may include, for example, a magnetic storage device (e.g., a hard drive), an optical storage device, and/or a solid state drive. The components of the transition adjustment device 200 are connected via a bus. Also, the transition adjustment device 200 includes an operating system, which manages one or more of the hardware, the processes, the interrupts, the memory, and the file system.

The transition adjustment device 200 also includes a focal transition module 210, an interface generation module 215, and a mask generation module. The focal transition module 210 determines one or more focal settings for one or more areas (e.g., areas of interest, transitional areas) in an image and receives user selections of focal settings (e.g., via the I/O interface 203) for respective areas in the image.

The interface generation module 215 generates an interface that indicates areas (e.g., areas of interest, transitional areas) in an image and their respective focal settings. The interface generation module 215 may also allow a user to configure the interface, for example by selecting one or more settings that will be included in the interface, the format of the interface, etc. For example, the interface generation module 215 may let a user select an interface to show aperture settings, a three-dimensional representation of the focal settings for the image, a two dimensional representation of the focal settings for the image, etc. The interface generation module 215 may also generate a preview of the image that shows the image with the selected focal settings applied to the image. The interface may then be transmitted to the display device 250 for display.

The mask generation module 220 generates aperture parameters masks and/or electronic aperture masks based on the focal settings, such as masks that implement the focal settings. An electronic aperture may indicate which aperture is selected for each super-pixel in a system that includes super-pixels and multi-aperture arrays. An aperture parameter mask is a spatial mask that indicates which is the aperture for each region or pixel of the image. It could be encoded as fstop (such as 3.5, 4, 4.5, 5, 5.6, 6.3, 7.1, 8, 9, 10, 11, 13, 14, 16, 18, 20, 22) or any other numerical parameter that can be related to an f-number. The aperture parameter mask then could be correlated to the electronic aperture mask that indicates which pixel in each super-pixel is selected for each super-pixel in the image. The mask generation module 220, interface generation module 215, and/or the focal transition module 210 may be configured with the capabilities of the image capturing device 240 (e.g., an aperture array) and not allow selection of focal settings that are not within the capabilities of the image capturing device.

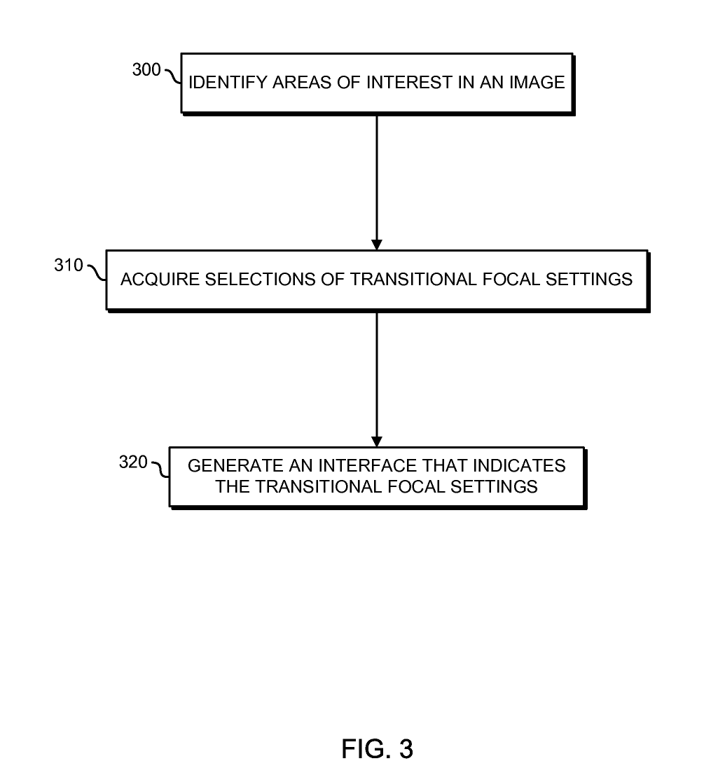

FIG. 3 is a block diagram that illustrates an embodiment of a method for adjusting focal transitions. Other embodiments of this method and the other methods described herein may omit blocks, may add blocks, may change the order of the blocks, may combine blocks, and/or may divide blocks into separate blocks. Additionally, one or more components of the systems and devices described herein may implement the method shown in FIG. 3 and the other methods described herein.

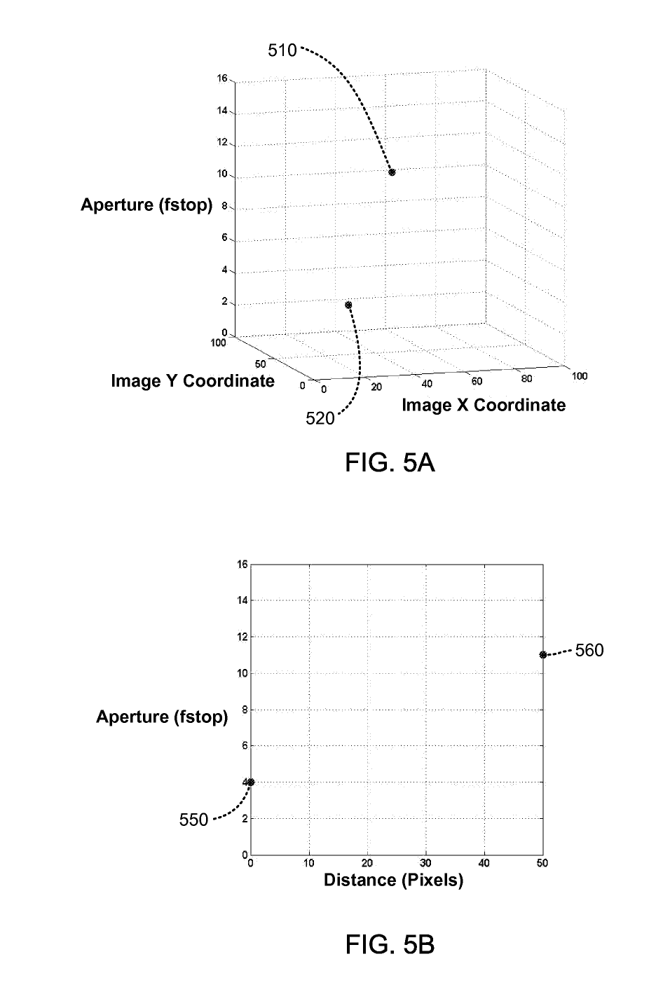

In block 300, areas of interest in an image are identified. The areas of interest may be identified by a user (e.g., by user selection) or by a device (e.g., a computing device). In block 310, selections of transitional focal settings are acquired, for example from a user via an input device. The selections of transitional focal settings may include the selections of focal settings for a discrete number of points in the transitional area, the selection of the shape of a line that corresponds to focal settings, etc. In block 320 an interface is generated that indicates the transitional focal settings. Examples of interfaces are illustrated in FIGS. 5-9.

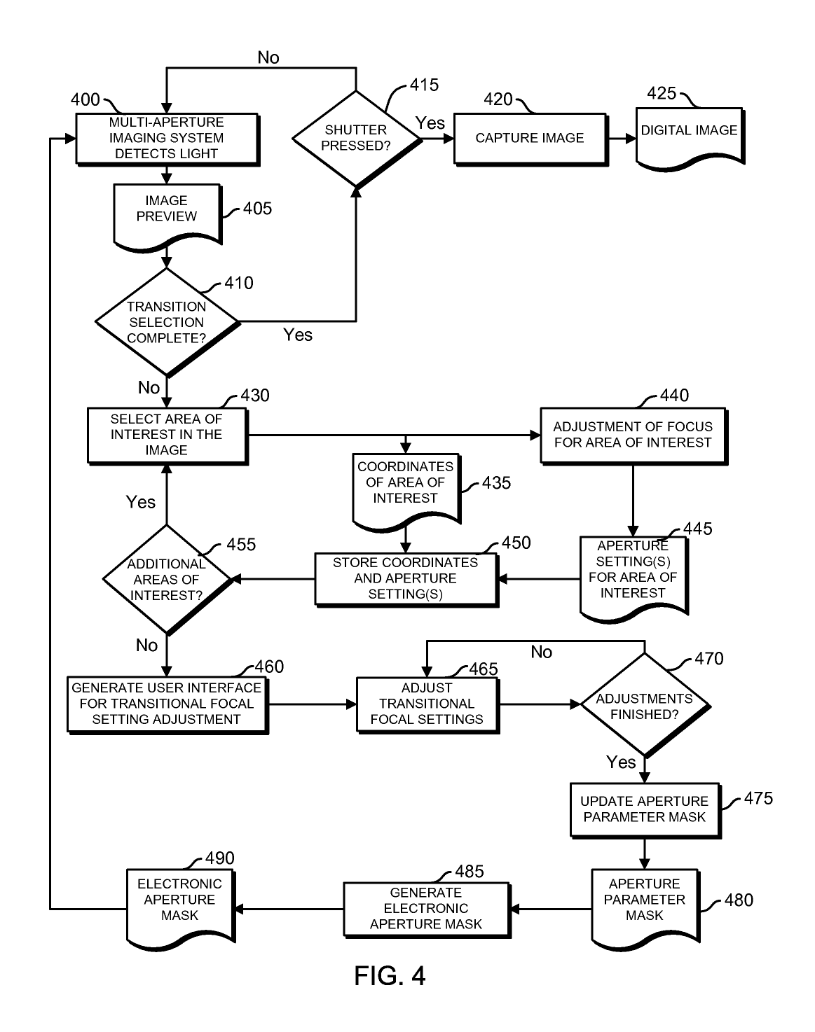

FIG. 4 is a block diagram that illustrates an embodiment of a method for adjusting focal transitions. In block 400, a multi-aperture imaging system detects light and generates an image preview 405 of a scene. In block 410, there is a determination if the transition selection is complete. If the transition selection is complete, flow proceeds to block 415 where it is determined if the shutter is pressed. If the shutter is pressed, flow proceeds to block 420 and a digital image 425 is captured that implements the selected transitions (e.g., an image that is captured by an image capturing device configured to the selected transitions). If the shutter is not pressed in block 415 (e.g., after a predetermined period of time), the method may return to block 400.

If in block 410 it is determined that the transition selection is not complete, the flow proceeds to block 430, where an area of interest in the image is selected, for example by a user or by a computing device, and the coordinates of the area of interest 435 are determined. In block 440 any adjustment of focus of the area of interest is determined, for example by a user (who may indicate the adjustment via one or more controls and/or interfaces) or by a computing device, and the aperture setting(s) for the area of interest 445 is generated. Next, in block 450, the coordinates of the area of interest and the aperture setting(s) are stored, for example in a computer readable medium. Moving to block 455, it is determined if there are any additional areas of interest in the image. If there are any additional areas of interest, the flow returns to block 430, where an area of interest is selected. If there are not any additional areas of interest, the flow proceeds to block 460.

In block 460, a user interface (e.g., a graphical user interface) for transitional focal setting adjustment is generated. The user interface may include indicators of the areas of interest, the transitional areas, and/or their respective focal settings and may be modified to show changes to the focal settings and/or areas of interest. Moving to block 465, one or more transitional focal settings are adjusted, for example by receiving user selections of transitional focal settings via the user interface. Next, in block 470, it is determined if the adjustments are finished. If the adjustments are not finished, flow returns to block 465. If the adjustments are finished, flow proceeds to block 475, where an aperture parameter mask 480 is updated (or generated, depending on the embodiment) that indicates the settings for respective apertures and/or one or more other settings (e.g., zoom settings, shutter settings), and in block 485 an electronic aperture mask 490 is generated based on the aperture parameter mask 480. Flow then returns to block 400, where the electronic aperture mask 490 is used by the multi-aperture imaging system to detect light. In some embodiments, aperture settings for different image capturing operations are generated, for example for an image capturing device that has a single aperture and that captures images with sequential image capturing operations that have different respective aperture settings. Furthermore, the image preview 405 may be generated to provide immediate feedback regarding changes made to any areas of interest and focal settings for the areas of interest and transitional areas.

FIGS. 5A and 5B illustrate embodiments of interfaces that indicate areas of interest 510, 520. FIG. 5A represents areas of interest 510, 520 and their respective aperture settings as approximate points in a three-dimensional coordinate space, where the X and Y axes indicate position in the image, and the Z axis indicates an aperture setting. In this example, an area of interest 510 is located in the coordinate space at approximately at 40, 50, 11 an is associated with an aperture setting of fstop 11, and an area of interest 520 is located in the coordinate space at approximately at 20, 0, 4 and is associated with an aperture setting of fstop 4. Areas of interest may also be represented with other indicia, for example two or three dimensional shapes, icons, colors, characters, numerals, etc.

FIG. 5B represents areas of interest 550, 560 and their respective aperture settings as approximate points in a two-dimensional coordinate space, where the X-axis indicates a distance in pixels between the areas of interest, and the Y axis indicates an aperture setting. An area of interest 550 is located in the coordinate space at approximately 0, 4 and is associated with an aperture setting of fstop 4, and an area of interest 560 is located in the coordinate space at approximately 50, 11 and is associated with an aperture setting of fstop 11.

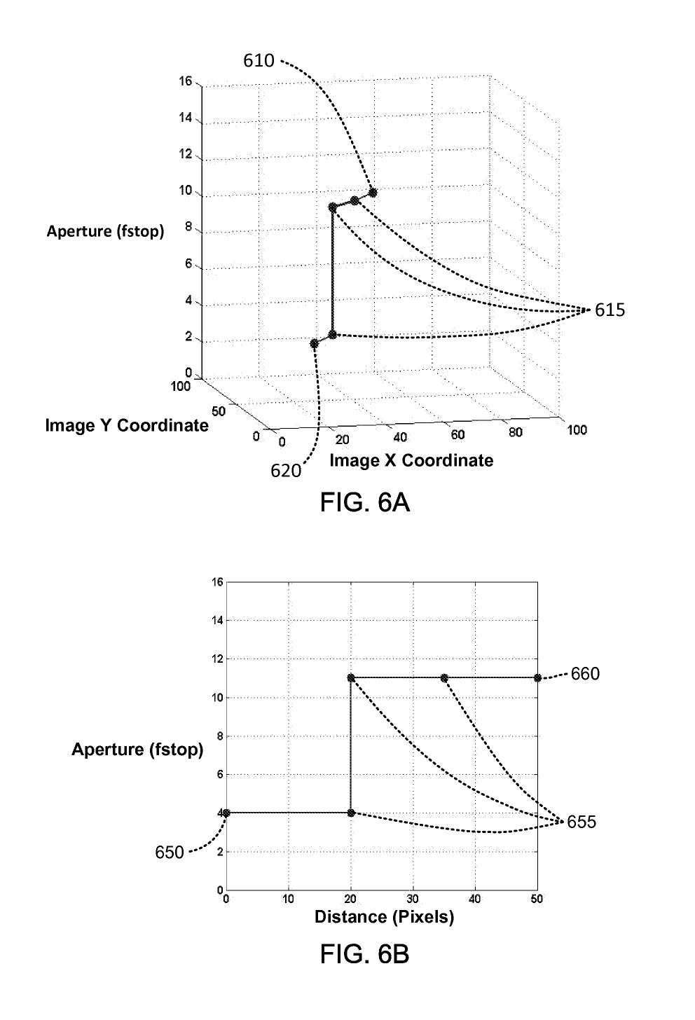

FIGS. 6A and 6B illustrate embodiments of interfaces that indicate focal transitions between areas of interest. FIG. 6A represents areas of interest 610, 620 and their respective aperture settings as approximate points in a three-dimensional coordinate space, where the X and Y axes indicate position in the image, and the Z axis indicates an aperture setting. FIG. 6A also illustrates transitional aperture settings 615 that indicate aperture settings for the transitional area between the areas of interest 610, 620. In the example shown in FIG. 6A, the transitional aperture settings 615 indicate a relatively abrupt change in the aperture setting between fstop 11 and fstop 4 in the transitional area. Though the embodiment of FIG. 6A illustrates the transitional aperture settings 615 as points joined by a line, in other embodiments the transitional aperture settings may be represented by other indicia, including one or more lines, surfaces, shapes, icons shadings, discrete points, etc. For example, if there are three or more areas of interest and they are represented in a three dimensional coordinate space, a surface may be used to indicate the focal settings for the transitional areas.

FIG. 6B represents areas of interest 650, 660 and their respective aperture settings as approximate points in a two-dimensional coordinate space, where the X-axis indicates a distance in pixels between the areas of interest, and the Y axis indicates an aperture setting. FIG. 6B also illustrates transitional aperture settings 655 for the transitional area between the areas of interest 650, 660. In the example shown in FIG. 6B, the transitional aperture settings 615 indicate a relatively abrupt change in the aperture setting between fstop 4 and fstop 11 at about X=20 in the transitional area. Though FIGS. 6A and 6B show aperture settings and relatively abrupt transitions, other embodiments may show different settings and/or transitions.

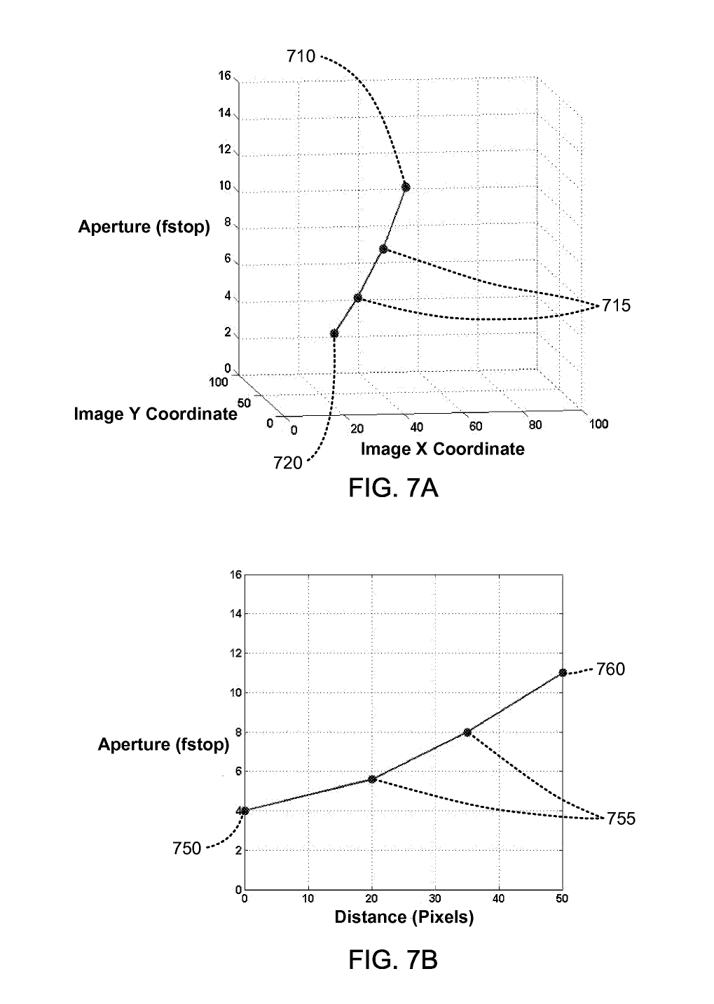

FIGS. 7A and 7B illustrate embodiments of interfaces that indicate focal transitions between areas of interest. In the example shown in FIG. 7A, the transitional aperture settings 715 indicate a relatively gradual change in the aperture settings between fstop 11 and fstop 4 in the transitional area. Similarly, in the example shown in FIG. 7B the transitional aperture settings 755 indicate a relatively gradual change between fstop 4 and fstop 11 in the transitional area. For example, at X=20 the aperture setting is approximately 5.8, and at X=35 the aperture setting is approximately 8.

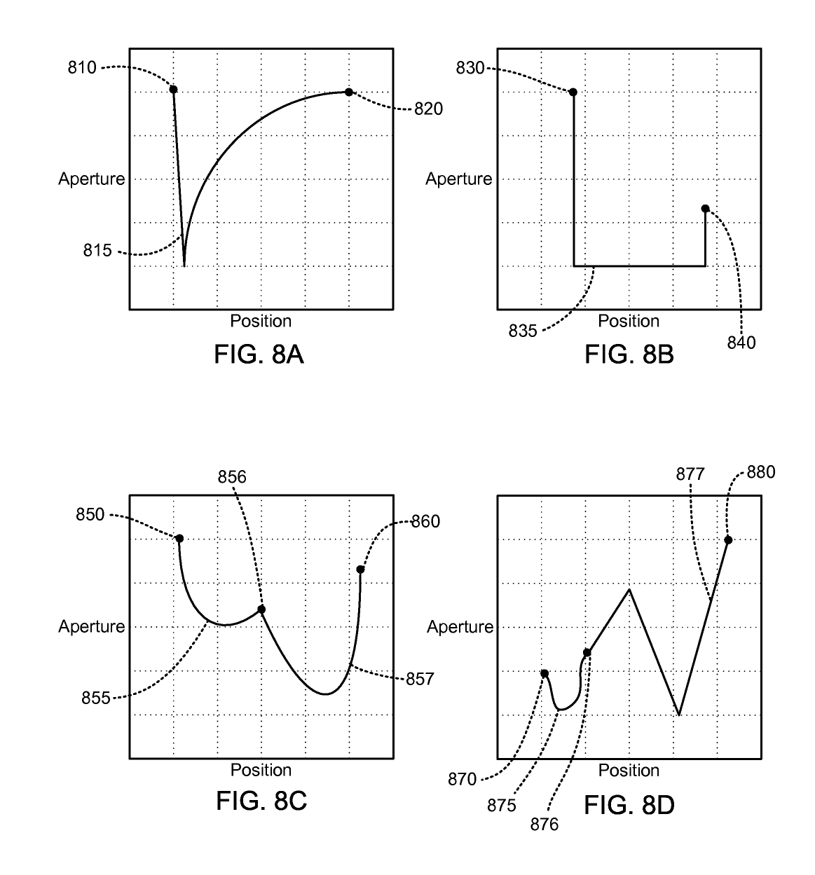

FIGS. 8A, 8B, 8C, and 8D illustrate embodiments of interfaces that indicate focal transitions between areas of interest. FIGS. 8A, 8B, 8C, and 8D include two-dimensional coordinate space representations of areas of interest, transitional areas, and their respective focal settings, where the X-axis shows position in the image and the Y-axis shows aperture settings. FIG. 8A includes areas of interest 810 and 820 and transitional aperture settings 815 between the areas of interest 810 and 820. The transitional aperture settings 815 illustrate a relatively abrupt change in aperture settings for part of the transitional area and a gradual change in aperture settings for part of the transitional area. FIG. 8B includes areas of interest 830 and 840 and transitional aperture settings 835, which show a relatively abrupt aperture settings transition between the areas of interest and the transitional area. FIG. 8C includes areas of interest 850, 856, and 860 and transitional aperture settings 855 and 857, which show relatively gradual and asymmetric transitions between the areas of interest 850, 856, and 860. FIG. 8D includes areas of interest 870, 876, and 880 and transitional aperture settings 875 and 877, which show other embodiments of focal transitions. The embodiments of areas of interest, transitional areas, and respective focal settings shown in the preceding FIGS. 5-8 are presented as examples, and the systems and methods described herein may be used to indicate and select other focal settings for areas of interest and/or transitional areas and also to capture images that implement the focal settings.

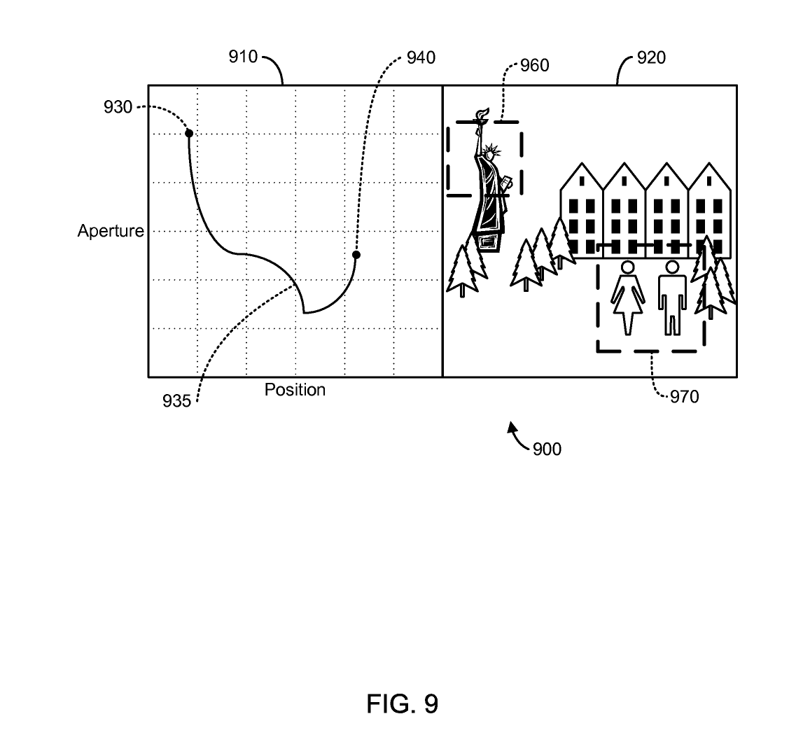

FIG. 9 illustrates an example of an embodiment of an interface 900 that indicates focal transitions between areas of interest. The interface 900 includes a first portion 910 that indicates aperture settings for areas of interest 930 and 940 and aperture settings for a transitional area 935. The interface 900 also includes a second portion 920 that displays a preview of an image and that indicates the areas of interest 960 and 970 in the image. In this embodiment, area of interest 930 in the first portion 910 corresponds to area of interest 960 in the second portion 920, and area of interest 940 in the first portion 910 corresponds to area of interest 970 in the second portion 920. A user may select one or more area of interest in the image, for example by touching a touch screen that displays the interface 900 at a location in the second portion 920 that corresponds to an area of interest, and the second portion 920 may be modified to indicate the selection. Also, a user may select the focal settings (e.g., aperture) for the areas of interest 930, 940 and for the transitional area 935 (e.g., by touching a touch screen that displays the interface 900 at a location in the first portion 910 that corresponds to the desired setting). Additionally, the first portion 910 may be modified as selections of aperture settings are received to show changes in aperture settings in response to received input. Furthermore, the preview of the image in the second portion 920 may be modified as selections are received to present a view of the image that implements the aperture settings that are indicated in the first portion 910.

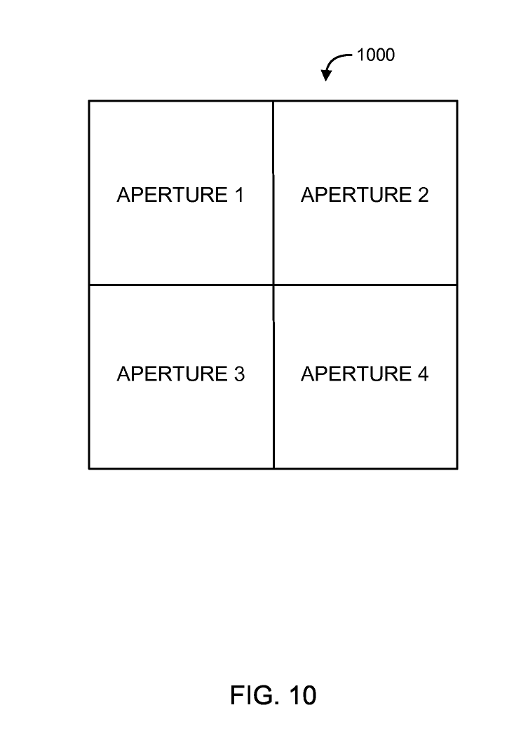

FIG. 10 illustrates an example of an embodiment of a super-pixel 1000. In this embodiment, the super-pixel 1000 includes four pixels, each of which may be associated with a different aperture (e.g., an aperture in an array of apertures, each of which may be configured based on a spatial aperture mask), and light may pass through a respective aperture to the associated pixel in the super-pixel 1000. Thus, even where any particular ray of light passes through one aperture, the super-pixel 1000 can detect light that passes through four different apertures. An aperture mask (e.g., electronic aperture mask) may be used to select a pixel in the super-pixel 1000 whose value is to be detected, and the value for the selected pixel may also be used to interpolate values for the other pixels in the super-pixel 1000. Thus, since an aperture mask may indicate which pixel in a super-pixel is selected and each pixel may be associated with an aperture, the aperture mask may indicate which aperture is selected for each super-pixel 1000.

The above described systems and methods can be achieved by supplying one or more storage media having stored thereon computer-executable instructions for realizing the above described operations to one or more devices that are configured to read the computer-executable instructions stored in the one or more storage media and execute them. In this case, the devices perform the operations of the above-described embodiments when executing the computer-executable instructions read from the one or more storage media. Also, an operating system on the one or more devices may implement the operations of the above described embodiments. Thus, the computer-executable instructions and/or the one or more storage media storing the computer-executable instructions therein constitute an embodiment.

Any applicable computer-readable storage medium (e.g., a magnetic disk (including a floppy disk and a hard disk), an optical disc (including a CD, a DVD, a Blu-ray disc), a magneto-optical disk, a magnetic tape, and a solid state drive (including flash memory, DRAM, SRAM) can be employed as a storage medium for the computer-executable instructions. The computer-executable instructions may be written to a computer-readable storage medium provided on a function-extension board inserted into the device or on a function-extension unit connected to the device, and a CPU provided on the function-extension board or unit may implement the operations of the above-described embodiments.

While the above disclosure describes illustrative embodiments, it is to be understood that the invention is not limited to the above disclosure. To the contrary, the invention covers various modifications and equivalent arrangements within the spirit and scope of the appended claims.

What is claimed is:

1. A method for setting a focal transition for an image capturing device, the method comprising:
receiving data including user selections of focal settings for respective areas of interest in an image;
generating a first interface that includes indicators of the focal settings for the respective areas of interest;
receiving data including user selections of transitional focal settings for respective transitional areas between the areas of interest; and
generating a second interface, the second interface including indicators of the transitional focal settings for the respective transitional areas between the areas of interest.

2. The method of claim 1, further comprising generating a spatial aperture mask based on the transitional focal settings, wherein the spatial aperture mask indicates aperture settings for respective apertures.

3. The method of claim 1, further comprising generating image capturing parameters for respective image capturing operations by an image capturing device based on the transitional focal settings, wherein the image capturing device is configured to capture images sequentially.

4. The method of claim 1, wherein the user selections are received via one or more of a touch screen, a microphone, a lever, a switch, a camera, a microphone, a joystick, and a button.

5. The method of claim 1, further comprising:
sending the first interface to a display device;
sending the second interface to a display device;
rendering the first interface on the display device; and
rendering the second interface on the display device.

6. The method of claim 1, wherein the indicators of the transitional focal settings include an indicator of a respective aperture setting for a respective transitional area.

7. A system for setting a focal transition, the system comprising:
a computer-readable medium;
an input interface configured to receive data that indicates selections from a user; and
one or more processors configured to cause one or more computing devices to
generate a first interface indicating focal settings for respective areas of interest in an image,
receive data indicating one or more user selections, the one or more user selections indicating focal settings for areas between the areas of interest in the image, and
generate a second interface indicating the focal settings for the areas between the areas of interest in the image.

8. The system of claim 7, wherein the one or more processors are further configured to cause the one or more computing devices to send the second interface to a display device.

9. The system of claim 7, wherein the second interface comprises a plot of the one or more user selections, wherein the plot indicates aperture values for the areas between the areas of interest.

10. The system of claim 9, wherein the plot is a two-dimensional plot or a tridimensional plot.

11. The system of claim 9, wherein the plot indicates two or more values for a respective area between the areas of interest.

12. The system of claim 7, wherein the second interface indicates a gradual change in focal settings for a respective area between the areas of interest or wherein the second interface indicates an abrupt change in focal settings for a respective area between the areas of interest.

13. One or more computer-readable media storing instructions that, when executed by one or more computing devices, cause the one or more computing devices to perform operations comprising:
receiving one or more first user selections, the one or more first user selections indicating transitional focal settings between a first focal setting and a second focal setting, wherein the first focal setting is associated with a first area of an image, the second focal setting is associated with a second area of the image, and the transitional focal settings are associated with a transitional area of the image between the first area and the second area; and
generating a first interface indicating the transitional focal settings between the first focal setting and the second focal setting.

14. The one or more computer-readable media of claim 13, wherein the operations further comprise:
receiving one or more second user selections, the one or more second user selections indicating the first focal setting and the second focal setting, wherein the first interface indicates the first focal setting and the second focal setting.

15. The one or more computer-readable media of claim 13, wherein the operations further comprise:
generating the first focal setting and the second focal setting, wherein the first interface indicates the first focal setting and the second focal setting.

16. The one or more computer-readable media of claim 13, wherein the operations further comprise sending the first interface to a display device configured to render the interface.

17. The one or more computer-readable media of claim 13, wherein transitional focal settings includes a plurality of focal settings for respective points, and wherein the points are located in the transitional area in the image.

18. The one or more computer-readable media of claim 13, wherein the operations further comprise generating a spatial aperture mask based on the transitional focal settings, wherein the spatial aperture mask indicates aperture settings for respective apertures of a plurality of apertures.

19. The one or more computer-readable media of claim 13, wherein the operations further comprise generating an electronic aperture mask for a plurality of super-pixels based on the transitional focal settings, wherein the electronic aperture mask indicates a selected pixel from a respective super-pixel in the plurality of super-pixels.
